(19) United States
(12) Patent Application Publication
(10) Pub. No.: US 2008/0228550 A1
(43) Pub. Date: Sep. 18, 2008

(54) APPARATUS AND METHOD FOR UTILIZING A TASK GRID TO GENERATE A DATA MIGRATION TASK

(75) Inventors: Aun-Khuan TAN, Sunnyvale, CA (US); Kirubakaran PAKKIRISAMY, San Ramon, CA (US)

Correspondence Address: COOLEY GODWARD KRONISH LLP;ATTN: Patent Group, Suite 1100, 777 - 6th Street, NW, Washington, DC, 20001, US

(73) Assignee: BUSINESS OBJECTS, S.A., Levallois-Perret (FR)

(21) Appl. No.: 11/686,292

(22) Filed: Mar. 14, 2007

(51) Int. Cl. G06F 15/02; G05B 19/418; G06F 17/00; G06F 3/00

(52) U.S. Cl. 705/9; 715/751; 705/8; 715/212

(57) ABSTRACT

A computer readable storage medium includes executable instructions to present a task grid to a set of users. A specification of target column information and source column information is accepted from the set of users to produce a data migration task grid. A data migration task is generated from the data migration task grid. The data migration task is processed.

### BRIEF DESCRIPTION OF THE INVENTION

This invention relates generally to data processing in a networked environment. More particularly, this invention relates to a task grid that may be populated by a group of users to specify a data migration task.

### BACKGROUND OF THE INVENTION

A data migration task moves data from a source (e.g., a database) to a target (e.g., another database, a data mart or a data warehouse). One form of data migration task is referred to as Extract, Transform and Load (ETL). The first part of an ETL process is to extract the data from a source system. Most data warehousing projects consolidate data from different source systems. Each separate system may use a different data organization or format. Common data source formats are relational databases and flat files. Extraction converts the data into a format for transformation processing. The transform phase applies a series of rules or functions to the extracted data to derive the data to be loaded. The load phase loads the data into the data warehouse.

Another form of data migration task is referred to as Enterprise Information Integration (EII). EII uses data abstraction to address data access challenges associated with data heterogeneity and data contextualization. EII provides uniform data access and uniform information representation.

Proper design of a data migration task requires a thorough understanding of the source systems from which data needs to be migrated. Unfortunately, one individual typically does not have expertise in a number of source systems. Therefore, there is a need to share information among a number of individuals to properly specify a data migration task. Similarly, it is frequently desirable to have one individual perform high level strategic mappings, while another individual provides lower level data entry mappings.

In view of the foregoing, it would be desirable to provide a new technique to support the collaborative specification of a data migration task.

### SUMMARY OF THE INVENTION

The invention includes a computer readable storage medium with executable instructions to present a task grid to a set of users. A specification of target column information and source column information is accepted from the set of users to produce a data migration task grid. A data migration task is generated from the data migration task grid. The data migration task is processed.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

FIG. 3 illustrates a project specification graphical user interface (GUI) that may be utilized in accordance with an embodiment of the invention.

FIG. 4 illustrates a data migration task grid utilized in accordance with an embodiment of the invention.

FIG. 5 illustrates a data migration task grid configured to support incremental task updates in accordance with an embodiment of the invention.

FIG. 6 illustrates a data migration task grid with a non-scrollable target column utilized in accordance with an embodiment of the invention.

FIG. 7 illustrates a data migration task grid supporting different data entry mechanisms in accordance with an embodiment of the invention.

FIG. 8 illustrates a data migration task grid with a matched source column function in accordance with an embodiment of the invention.

FIG. 9 illustrates a GUI to generate a data migration task in accordance with an embodiment of the invention.

FIG. 10 illustrates a data migration task grid supporting approved column mappings in accordance with an embodiment of the invention.

FIG. 11 illustrates a data migration task grid displaying a history of approved column mappings.

FIG. 12 illustrates a data migration task grid supporting the specification of textual notes in accordance with an embodiment of the invention.

FIG. 13 illustrates a data migration task grid displaying a column mapping in response to a selection of a row in accordance with an embodiment of the invention.

FIG. 14 illustrates a data migration task grid supporting administrative settings in accordance with an embodiment of the invention.

FIG. 15 illustrates a data migration task grid supporting mapping validation rules in accordance with an embodiment of the invention.

Like reference numerals refer to corresponding parts throughout the several views of the drawings.

### DETAILED DESCRIPTION OF THE INVENTION

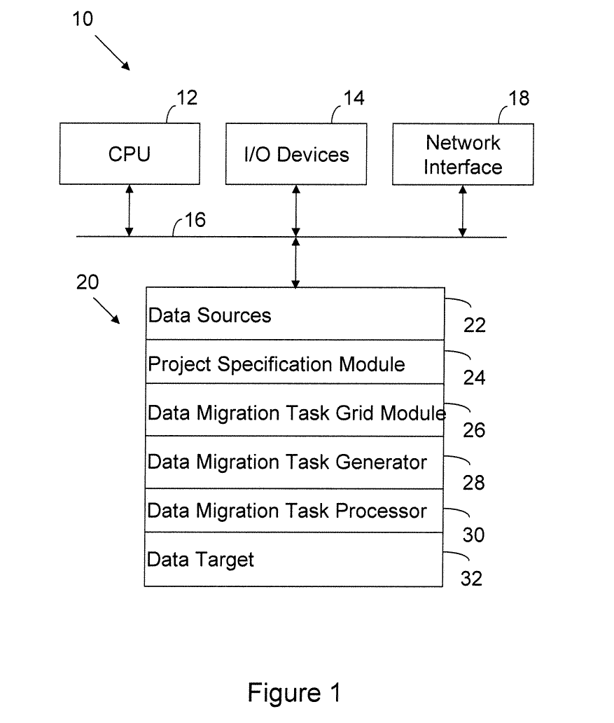

FIG. 1 illustrates a computer 10 configured in accordance with an embodiment of the invention. The computer 10 includes standard components, such as a central processing unit 12 connected to input/output devices 14 via a bus 16. The input/output devices 14 may include a keyboard, mouse, display, printer, and the like. A network interface circuit 18 is also connected to the bus 16. The network interface circuit 18 facilitates communications with a network (not shown). Thus, the computer 10 may operate in a client-server environment. In one embodiment, the computer 10 is an application server accessible by a large number of clients that specify a data migration task in accordance with embodiments of the invention.

A memory 20 is also connected to the bus 16. The memory 20 includes data and executable instructions to implement operations associated with the invention. The memory 20 stores a set of data sources 22. The data sources 22 may include custom applications, relational databases, legacy data, customer data, supplier data, and the like. Typically, the data sources 22 are distributed across a network, but they are shown in a single memory 20 for the purpose of convenience.

The memory 20 also stores a project specification module 24. The project specification module 24 includes executable instructions to define and update a data migration task.

The memory 20 also stores a data migration task grid module 26. The data migration task grid module 26 includes executable instructions to specify a task grid, which is populated by one or more users to form a data migration task. The input may be received from a single user. However, in many applications, the input is received by a large number of users working collaboratively. For example, for a given data migration task, a first expert associated with a first data source may provide input on the intricacies of the first data source, while a second expert associated with a second data source may provide input on the intricacies of the second data source.

A data migration task generator 28 is also stored in memory 20. The data migration task generator 28 includes executable instructions to generate a data migration task from the data migration task grid. As previously indicated, the data migration task grid specifies source column to target column mappings. The data migration task generator 28 utilizes these mappings to generate a set of instructions that implement the movement of data from the source columns to the target column. These instructions may be generated in bulk by processing an entire data migration task grid or incrementally by processing new information entered into the data migration task grid. For example, incremental updates may be implemented using Asynchronous Java® Script and XML (AJAX). For example, AJAX may be used to facilitate incremental input mappings on a column-by-column basis without having to reload the entire grid.

A data migration task processor 30 executes the mappings generated by the data migration task generator 28 to migrate data from sources to a data target 32, such as a data warehouse. Typically, the data target 36 would be on a separate machine, even though it is shown on the same machine in this example. Indeed, many or all of the modules of memory 20 may be distributed across a network. It is the operations of these modules that are significant, not how or where in a network they are implemented.

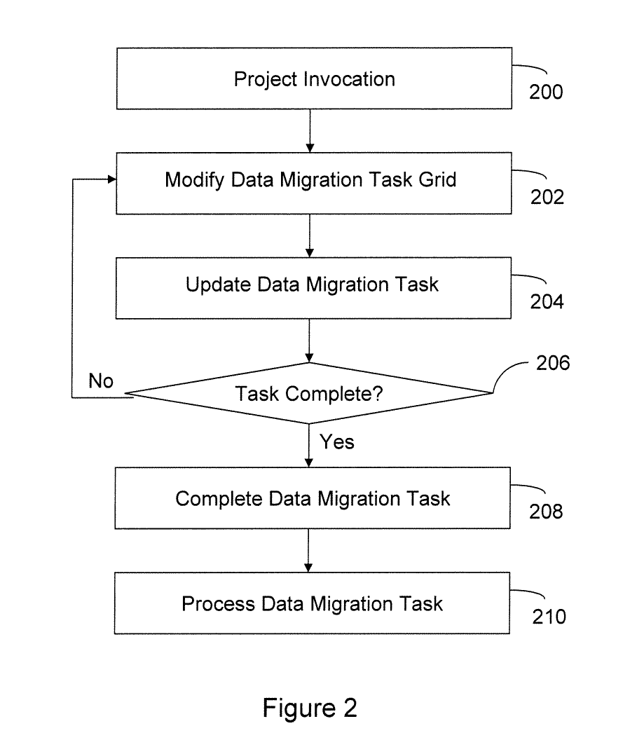

FIG. 2 illustrates processing operations associated with an embodiment of the invention. Initially, a project is invoked 200. The project specification module 24 may be used to implement this operation, as shown with an example below. A data migration task grid is then modified 202. That is, one or more uses create and modify a data migration task. This operation may be supported by the data migration task grid module. The user or users may operate a single computer, but more commonly, they will be distributed across a network. For example, the computer 10 of FIG. 1 may operate as a server collecting data migration task updates from various clients. In this case, computer 10 distributes the data migration task grid to various client machines. A user at each client machine updates the task grid and then uploads it into the computer 10. Standard concurrency control techniques are used to coordinate this operation.

The next processing operation of FIG. 2 is to update a data migration task 204 in accordance with the data in the data migration grid. This operation may be implemented with the data migration task generator 28. One advantage of the invention is the ability to incrementally update the specification of the data migration task. This allows a user to continue to specify column mappings while previous column mappings are saved to the server piecemeal.

If the task is not complete (block 206—No), then control returns to block 202. Otherwise (block 206—Yes), the data migration task is completed 208. The data migration task may then be processed 210. This operation may be implemented with the data migration task processor 30. Standard techniques may be used to implement the data migration.

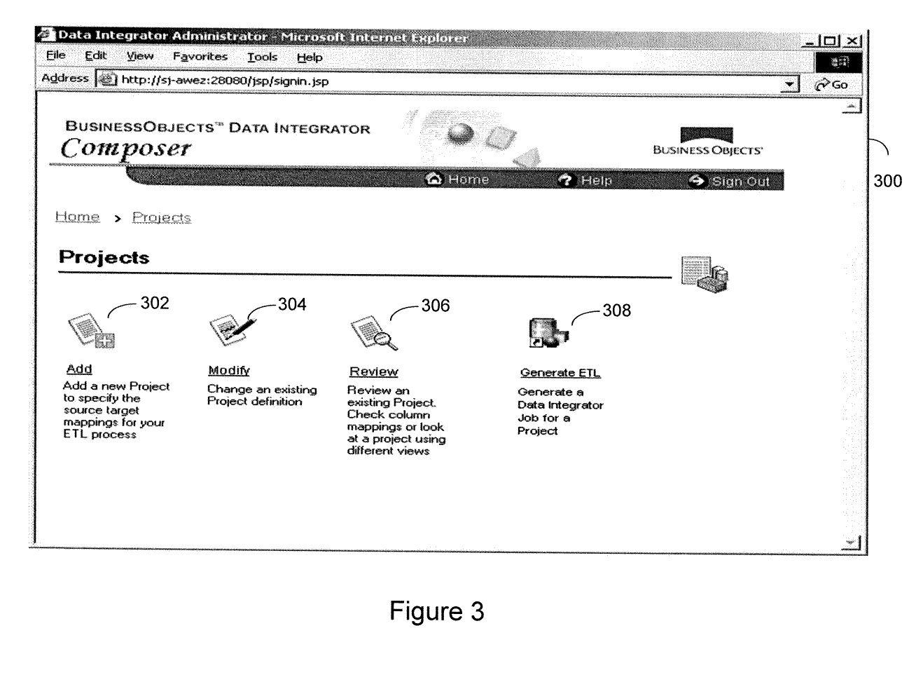

FIG. 3 illustrates a project specification GUI 300 that may be used in accordance with an embodiment of the invention. The project specification GUI 300 may be generated by the project specification module 24. In this embodiment, the project specification GUI 300 includes an icon 302 to activate a new data migration project (an ETL process in this example). Icon 304 allows one to invoke and modify a data migration task grid associated with an existing data migration task. Icon 306 allows one to review an existing data migration task grid. Finally, icon 308 may be used to implement a data migration task. For example, the data migration task processor 30 may be called to implement an ETL data migration task specified by the data migration task grid.

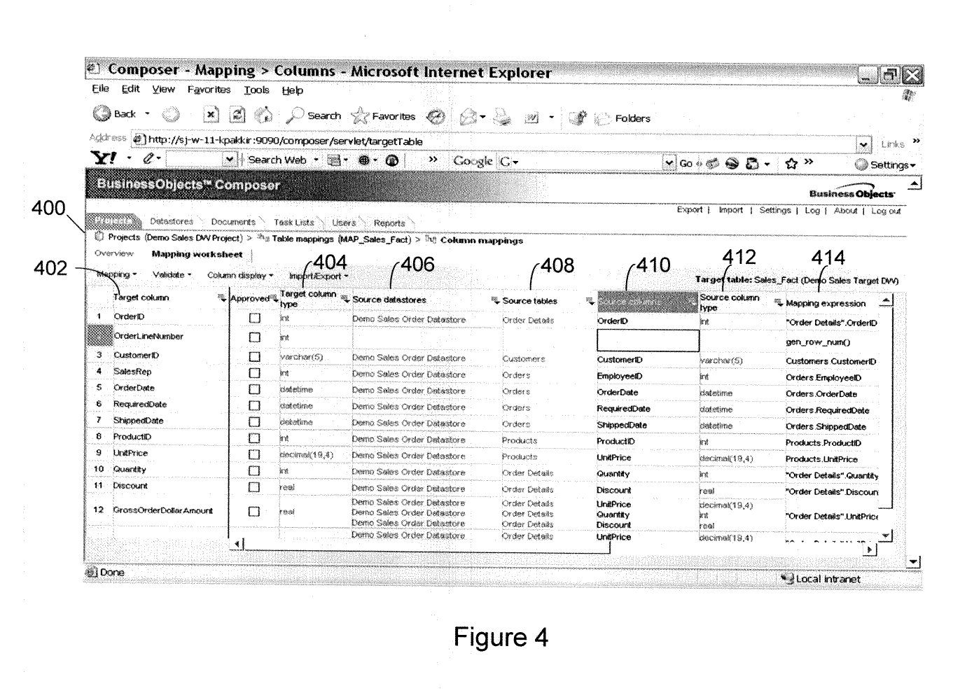

FIG. 4 illustrates a data migration task grid 400 configured in accordance with an embodiment of the invention. The task grid 400 includes a set of grid rows numbered 1-12 and a set of grid columns 402-414. The first column 402 is the target column of the data target. Column 404 may specify the target column type.

This data target receives data from various mapped data sources. Column 406 specifies source data stores, column 408 specifies source tables, column 410 specifies source columns, column 412 specifies source column type, and column 414 specifies a mapping expression.

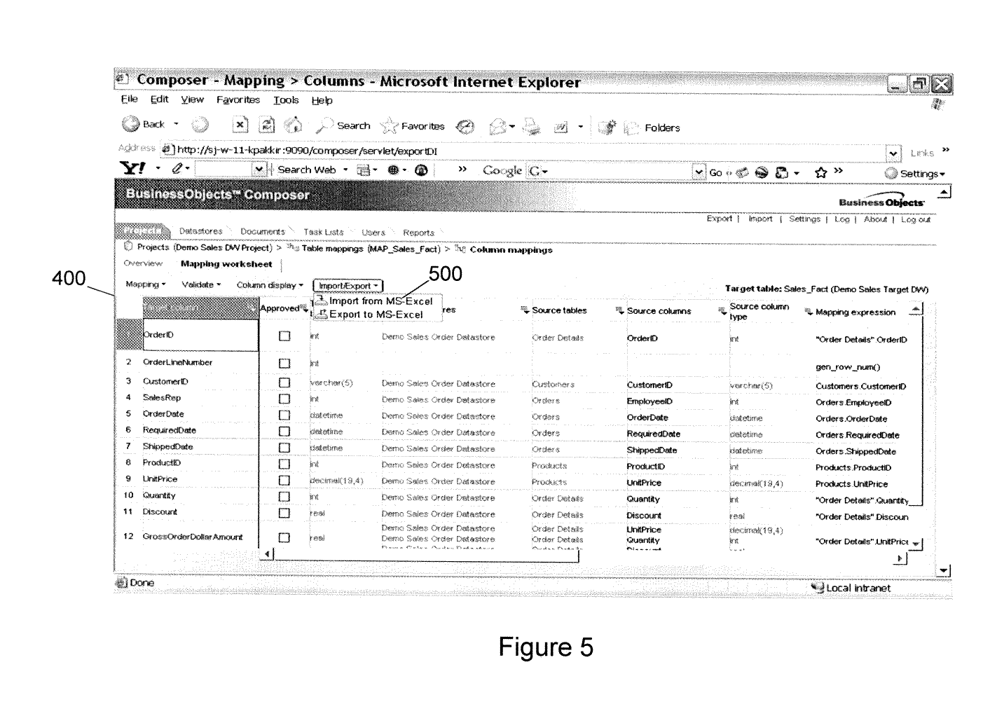

FIG. 5 illustrates the task grid 400 implemented with an import and export option. In particular, a pull-down menu 500 allows one import or export the task grid 400 to a spreadsheet application (e.g., Microsoft® Excel®). In this example, the task grid is implemented with a commercially available spreadsheet. Pull-down menu 500 allows a user to edit data migration tasks offline and then subsequently merge the task grid with a server (e.g., the data migration task generator 28 and data migration task processor 30 of computer 10).

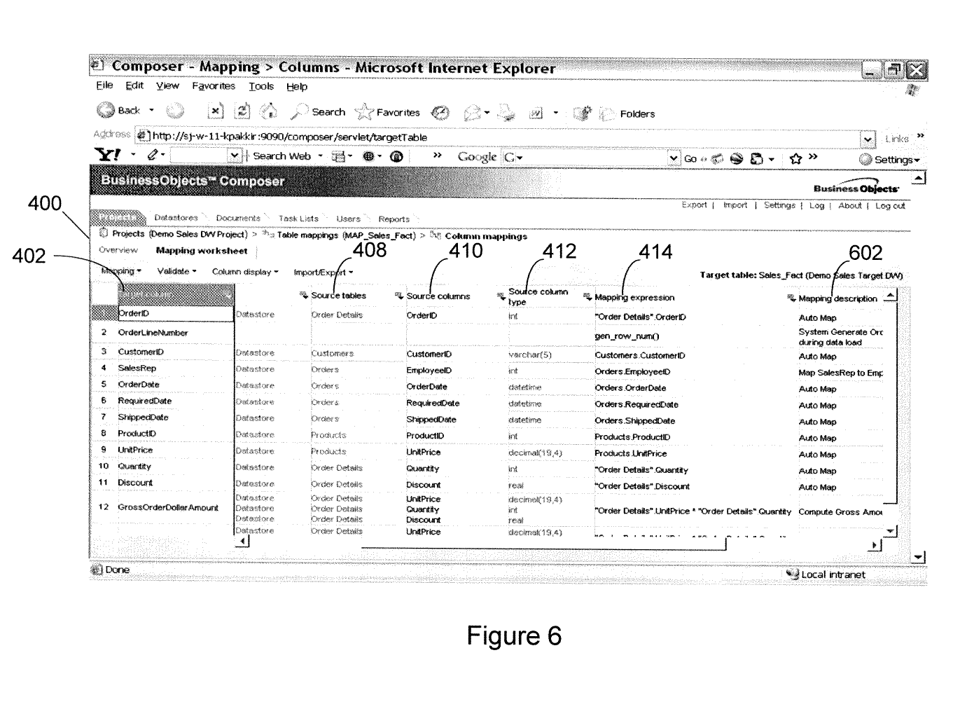

FIG. 6 illustrates the task grid 400 in a configuration in which a slider bar 600 is moved to the right to expose additional columns, such as the mapping description column 602. Observe here that the target column 402 is still visible. An embodiment of the invention utilizes a non-scrollable target column 402 so that a user can always observe the target column information, regardless of the source column information that is viewable.

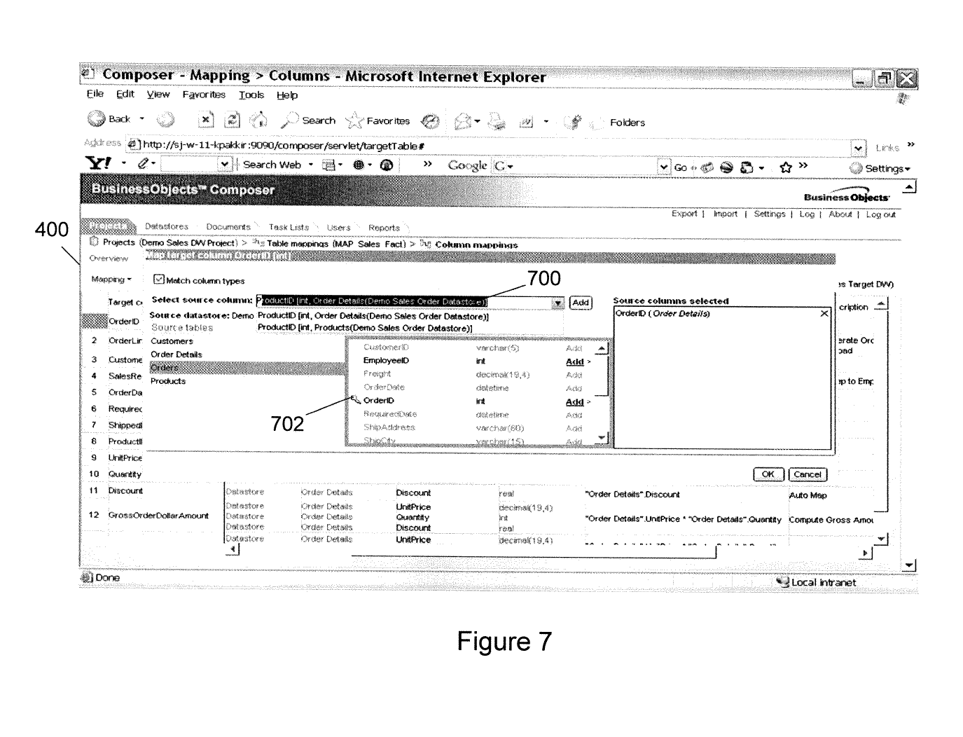

FIG. 7 illustrates the task grid 400 supporting different data entry mechanisms. The data migration task grid module 26 may be implemented to recognize a partially typed source column name, which is typed into block 700. Alternately, or in addition, a point-and-click window 702 may be used to display possible source columns. A separate tool may be used to analyze a data source and generate information characterizing column names. These names may then be used by the data migration task grid module 26 to match partially typed column names and/or produce appropriate pint-and-click windows. Observe that this approach eliminates errors since the specified column name must match known schema.

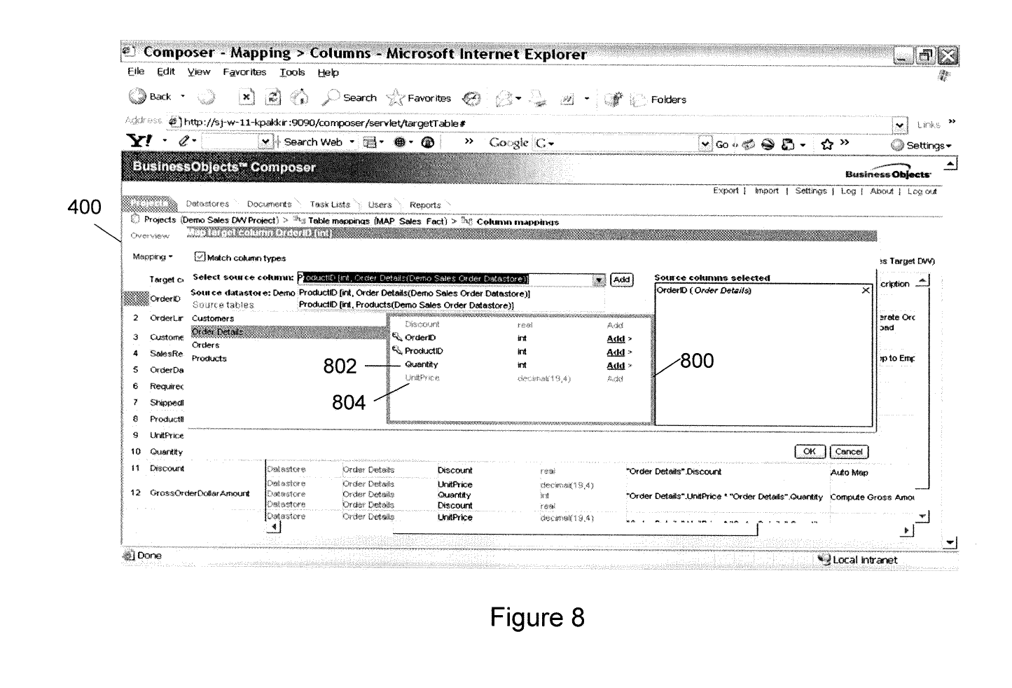

FIG. 8 illustrates that the task grid 400 may be implemented to highlight only those source columns that have the same data type as a target column. For example, point-and-click window 800 highlights column names 802 that are of integer type, which corresponds to the integer type specified by the target column. On the other hand, columns of real numbers or decimals are not highlighted (e.g., 804). This feature simplifies data migration task specification and also reduces errors.

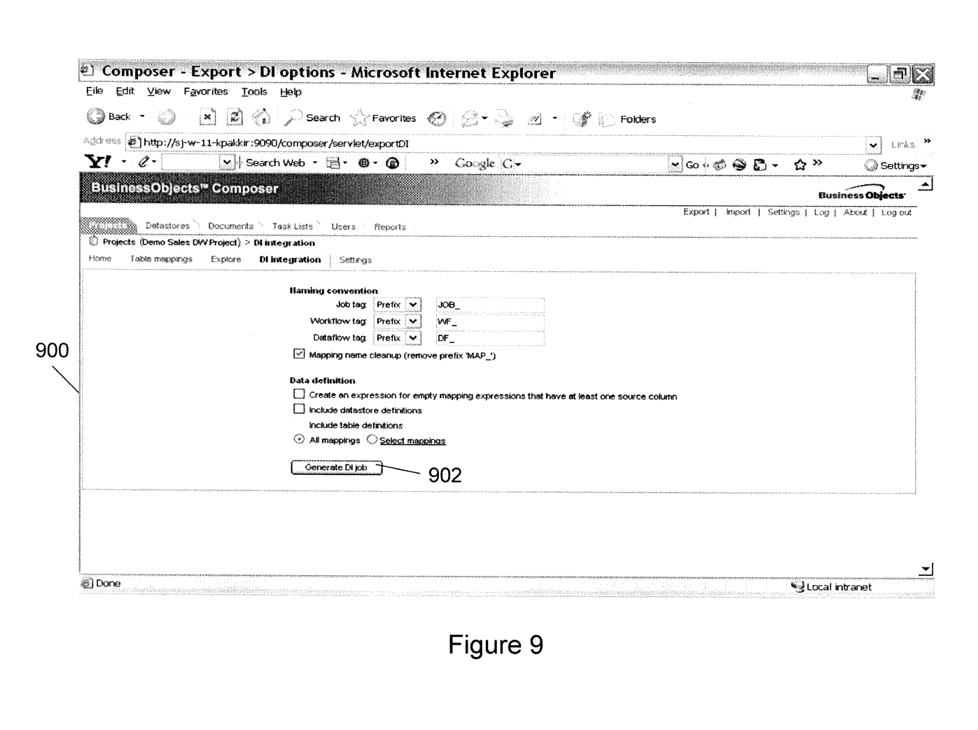

FIG. 9 illustrates a GUI 900 which may be used to initiate a data migration task. The GUI 900 includes a button 902 to generate a data integration job. For example, the GUI 900 may be associated with the data migration task processor 30. The same GUI or a similar GUI may be used to specify ETL jobs and/or EII jobs.

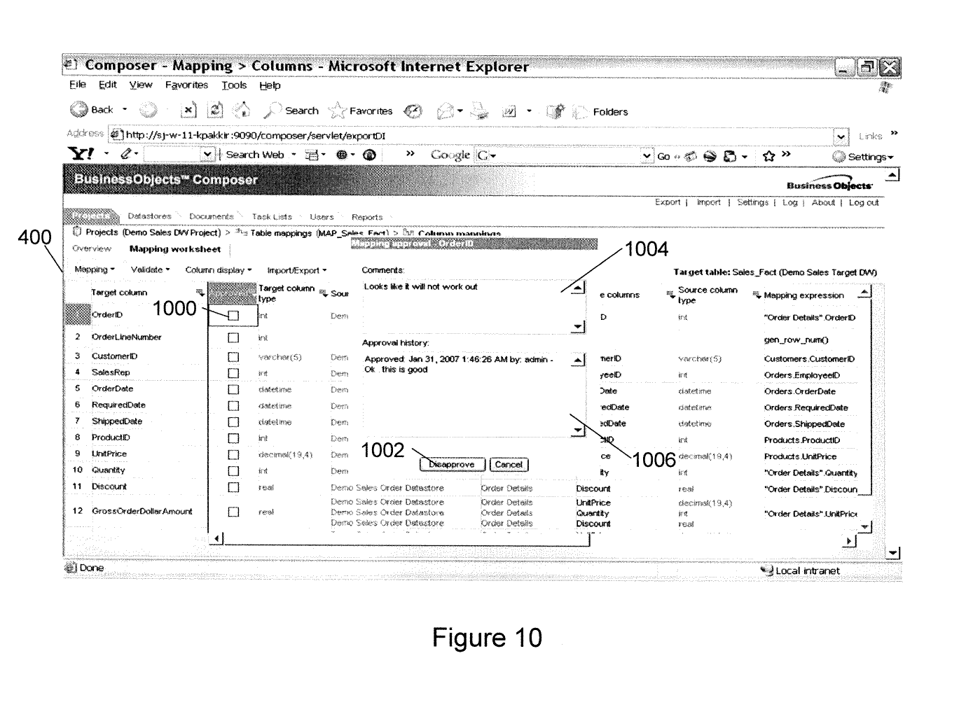

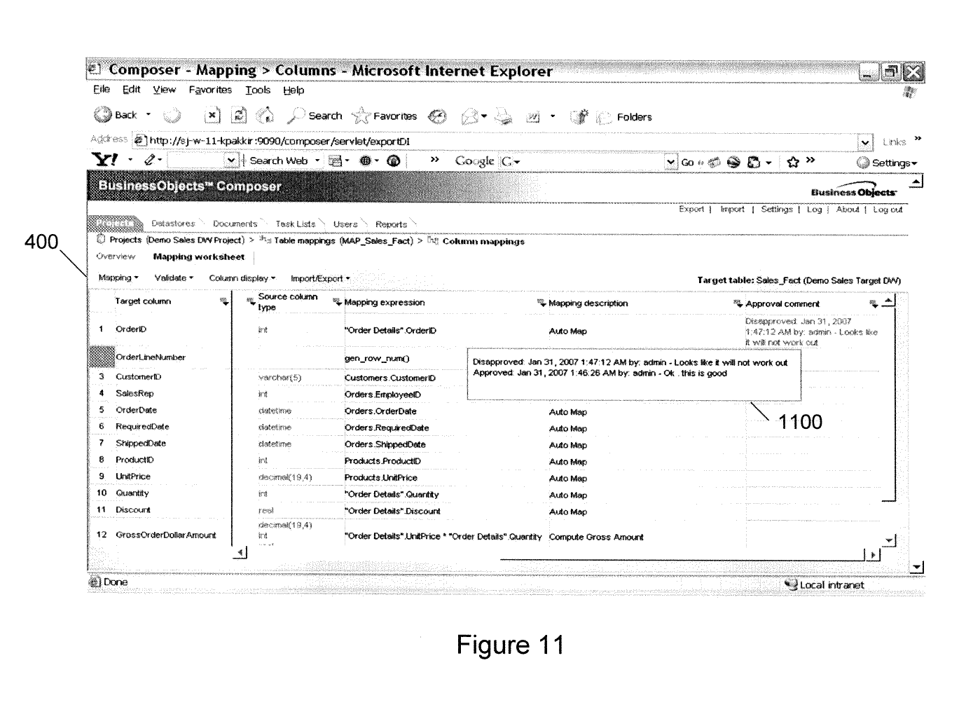

FIG. 10 illustrates a task grid 400 which supports approval of column mappings. For example, certain employees in an enterprise may specify column mappings, while a supervisor is required to approve the column mappings. Approval may be supplied through a button 1000. Disapproval may be signaled with a disapprove button 1002. Disapproval may be accompanied with a comment block 1004. In addition, an approval history block 1006 may also be utilized. The data migration task grid module 26 controls access to the approval process and maintains approval history. FIG. 11 illustrates a task grid 400 with an alternate display of historical approved and disapproved column mappings in block 1100.

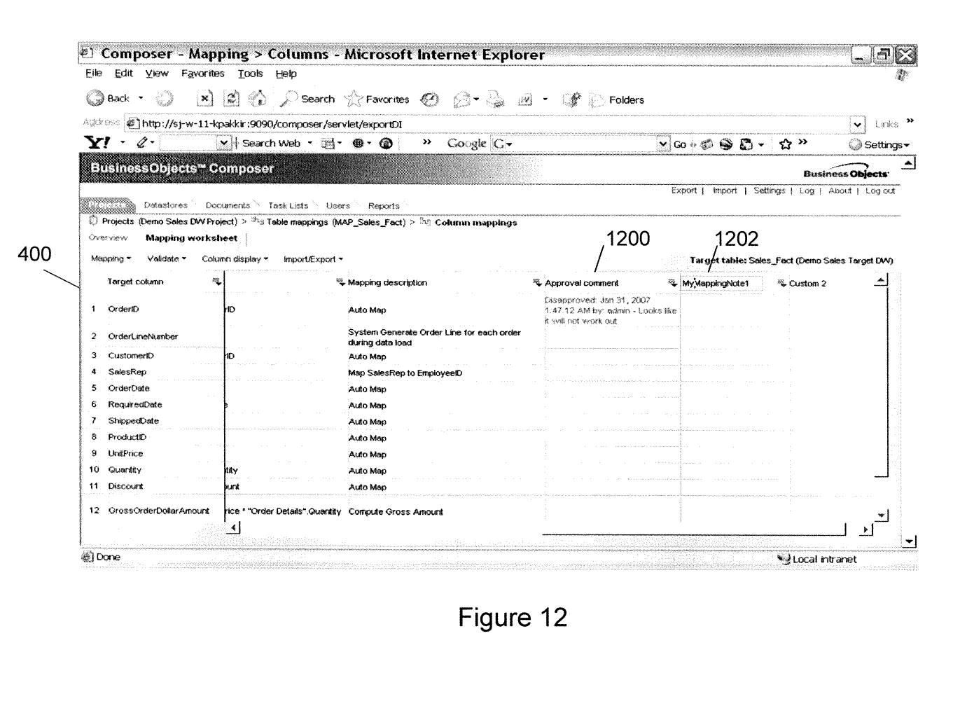

FIG. 12 illustrates a task grid 400 with approval comments in a column 1200 associated with the task grid 400. In addition, columns, such as column 1202, may be used to specify textual notes. Thus, the task grid itself may be used for textual notes.

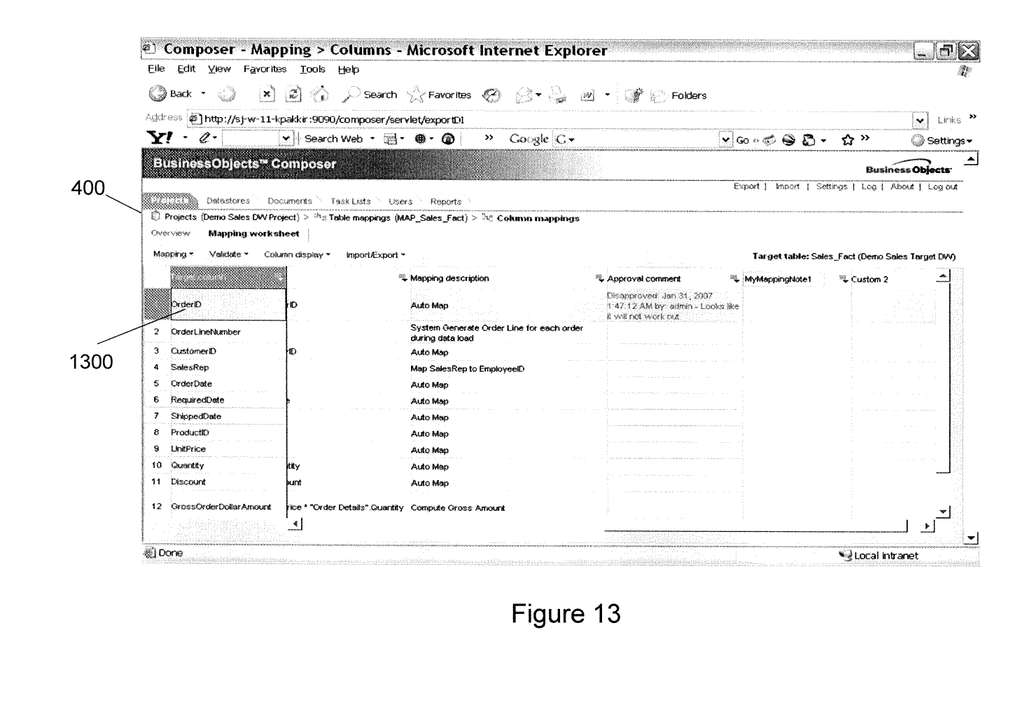

FIG. 13 illustrates a task grid 400 which supports the selection of a row 1300. The row selection results in the highlighting of the row to illustrate the column mappings. The highlighted row may then be manipulated with additional user interface tools, such as an edit lookup.

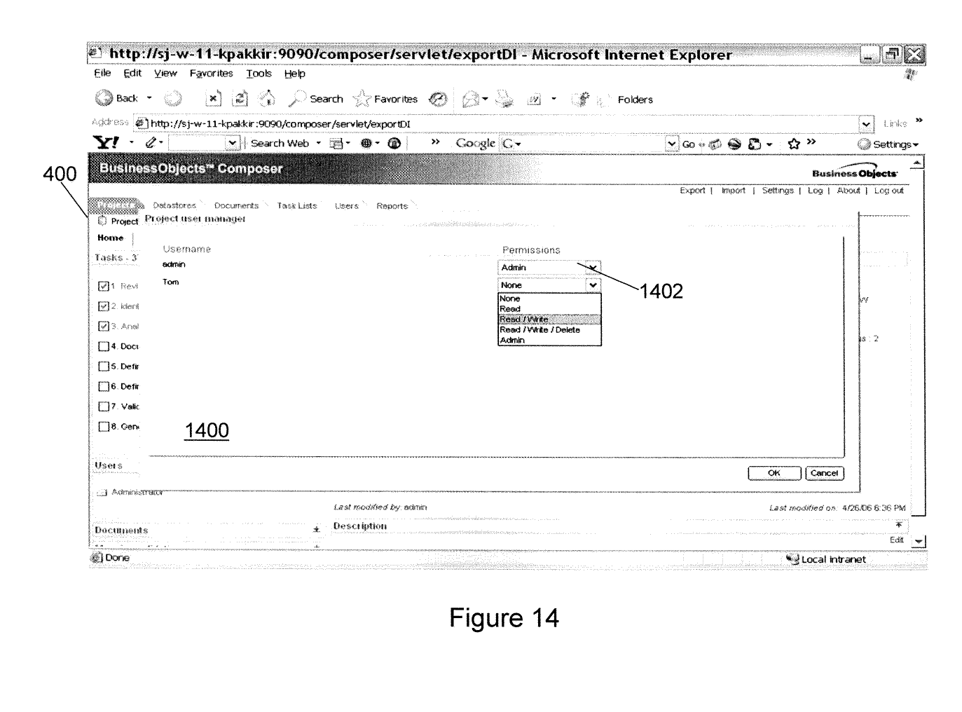

FIG. 14 illustrates a data migration task grid 400 that supports administrative settings. An administrator window 1400 facilitates the specification of permissions through a permissions window 1402. The administrative settings may be controlled and processed with the data migration task grid module 26.

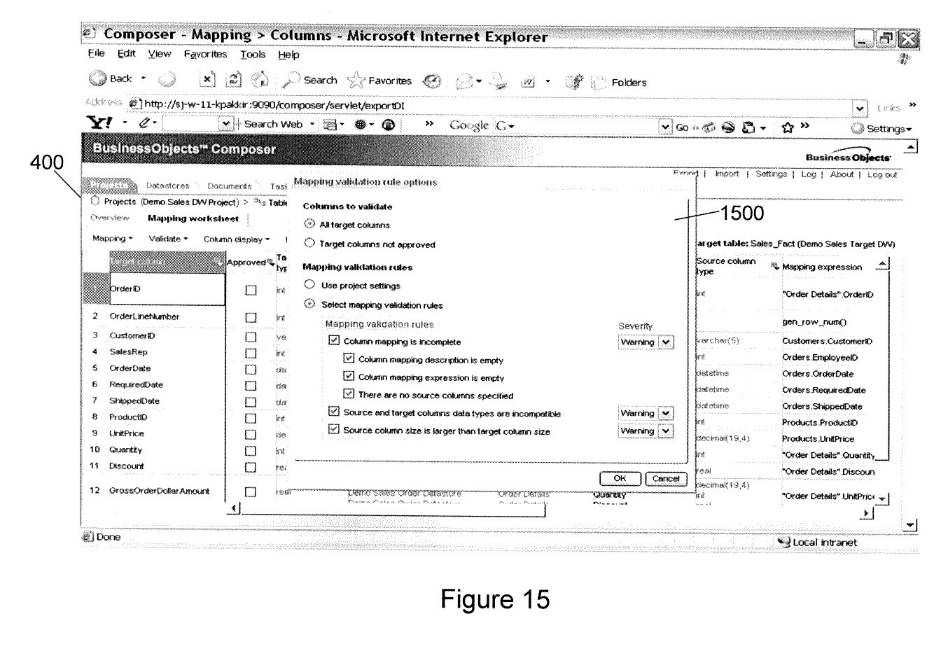

FIG. 15 illustrates a data migration task grid 400 with an associated administrator window 1500 which allows for the specification of mapping validation rules. This allows for the administration of the progress of a mapping project. A window of this type also allows an administrator to control the mapping performed by other participants in the work flow.

In one embodiment of the invention, the project specification module 24 facilitates the importation of table and column mapping information associated with an existing ETL or EII task. The project specification module 24 then populates a data migration task grid, which may be processed by the data migration task grid module 26 in the manner discussed above.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
present a task grid to a plurality of users;
accept a specification of target column information and source column information from the plurality of users to produce a data migration task grid; and
generate a data migration task from the data migration task grid.

2. The computer readable storage medium of claim 1 further comprising executable instructions to process the data migration task.

3. The computer readable storage medium of claim 1 wherein the task grid is a spreadsheet.

4. The computer readable storage medium of claim 1 wherein the task grid includes a non-scrollable target column.

5. The computer readable storage medium of claim 1 wherein the executable instructions to accept include executable instruction to accept a specification from an offline session.

6. The computer readable storage medium of claim 1 wherein the source column information is specified from a fragment of a source column name.

7. The computer readable storage medium of claim 1 wherein the source column information is specified from a pull-down menu.

8. The computer readable storage medium of claim 1 further comprising executable instructions to
match target column data type with possible source column data types to form a list of matched source columns; and
allow selection of a matched source column.

9. The computer readable storage medium of claim 1 wherein the data migration task is an extract, transform, load (ETL) task.

10. The computer readable storage medium of claim 1 wherein the data migration task is an enterprise information integration (Eli) task.

11. The computer readable storage medium of claim 1 further comprising executable instructions to support the approval of column mappings to produce approved column mappings.

12. The computer readable storage medium of claim 10 further comprising executable instructions to display a history of approved column mappings.

13. The computer readable storage medium of claim 1 further comprising executable instructions to support the specification of textual notes in the task grid.

14. The computer readable storage medium of claim 1 further comprising executable instructions to display a column mapping in response to selection of a row.

15. The computer readable storage medium of claim 1 further comprising executable instructions to process administrative settings.

16. The computer readable storage medium of claim 15 further comprising executable instructions to process administrative settings in the form of mapping validation rules.

17. The computer readable storage medium of claim 15 further comprising executable instructions to process administrative settings in the form of permissions.

18. The computer readable storage medium of claim 17 further comprising executable instructions to support permissions selected from read permission, read/write permission, and read/write/delete permission.

19. The computer readable storage medium of claim 1 further comprising executable instructions to support column mapping version control.

20. The computer readable storage medium of claim 1 further comprising executable instructions to facilitate the importation of table and column mapping information associated with an existing task.
